(19) United States
(12) Patent Application Publication
(10) Pub. No.: US 2013/0227789 A1
(43) Pub. Date: Sep. 5, 2013

(54) Apparatus and Method for the Transfer and Movement of Objects

(71) Applicants: Jill Reid Olson, Oconomowoc, WI (US); Brian P. Reid, Hartland, WI (US); Robert R. Olson, Oconomowoc, WI (US)

(72) Inventors: Jill Reid Olson, Oconomowoc, WI (US); Brian P. Reid, Hartland, WI (US); Robert R. Olson, Oconomowoc, WI (US)

(21) Appl. No.: 13/597,990

(22) Filed: Aug. 29, 2012

Related U.S. Application Data
(60) Provisional application No. 61/530,693, filed on Sep. 2, 2011.

(51) Int. Cl. A61G 1/048

(52) U.S. Cl. CPC A61G 1/048
USPC 5/625

(57) ABSTRACT

An apparatus and method for moving people, pets, and other objects that makes such movement easier when compared with conventional methods. A sling-type device is utilized in a variety of configurations for moving people, animals, and other objects. The various configurations include pet transfer, the transport of people, animals, and objects through rough terrain, emergency response applications, hunting applications including the transfer of animals from wooded off road areas, and in industrial settings including the use of a sling for the movement of cylinders, or larger, heavy, clumsy objects.

### CROSS-REFERENCE TO RELATED APPLICATIONS

This application claims priority under 35 USC §119(e) to U.S. Provisional Patent Application 61/530,693 filed Sep. 2, 2011, the entirety of which is incorporated herein by reference.

### FIELD OF THE INVENTION

The present invention relates to an object transfer device and method, and more specifically to an apparatus and method that makes moving people, pets, and other objects easier when compared with conventional methods.

### BACKGROUND

The movement and transportation of people and animals with disabilities, including those who have difficulty in moving themselves for reasons including degenerative and/or debilitating diseases and conditions, can present various challenges to both the person or animal attempting to move and the person attempting to assist in such movement. The challenges can vary depending upon the disability or infirmity of the person or animal being moved. The amount of difficulty in moving the person or animal generally increases with the severity of the disability or infirmity. In addition, unique challenges are presented When moving other large objects such as air or other gas tanks.

### SUMMARY OF THE INVENTION

The present invention relates to a method and apparatus for transporting people, animals and objects, including people and animals with disabilities or who have difficulty in moving themselves. More specifically, the present invention typically utilizes a sling-type device in a variety of configurations for moving people, animals, and other objects. For example, the present invention can be used in connection with the transport of people, animals, and objects through rough terrain, pet transfer, emergency response applications, hunting applications including the transfer of animals from wooded off road areas, and in industrial settings including the use of a sling for the movement of cylinders, or larger, heavy, clumsy objects. As another example, the present invention can be used to overcome the typical difficulty associated with moving a person with cerebral palsy because the person is in constant movement and hard to grasp.

By ensuring more ergonomic lifting positions and better weight distribution, the present invention potentially reduces the likelihood of back injuries and other related injuries to firefighters, Emergency Medical Services provider (“EMS”), and others who are involved in moving patients and other heavy objects.

The objects and advantages of the invention will appear more fully from the following detailed description of the preferred embodiment of the invention made in conjunction with the accompanying drawings.

### BRIEF DESCRIPTION OF THE DRAWINGS

FIG. 1 is a rescue/recovery chair according to the present invention;

FIG. 2A and 2B are a smaller rescue/recovery chair;

FIGS. 3A and 3B are another embodiment of a rescue/recovery chair;

FIG. 4 is a transfer chair;

FIG. 5 is a transfer sheet;

FIGS. 6A and 6B are extraction mats;

FIG. 7 is an evacuation sled;

FIG. 8 is a rough terrain extrication and transfer mat;

FIG. 9 is a plastic glider mat;

FIG. 10 is an under-belly pet transfer sling;

FIGS. 11A and B are an alternate embodiment of an under-belly pet transfer sling;

FIG. 12 is a pet transfer mat;

FIG. 13 is a large carry mat; and

FIG. 14 is an industrial cylinder transport mat.

### DETAILED DESCRIPTION OF THE INVENTION

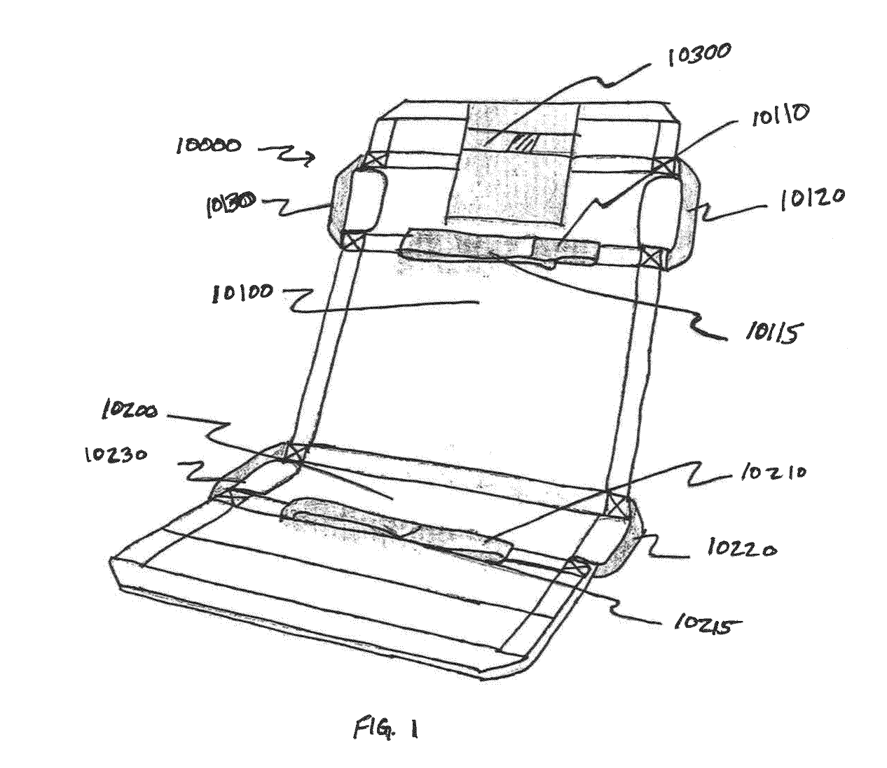

Referring to FIG. 1, a rescue/recovery chair 10000 according to one aspect of the present invention is shown. The rescue/recovery chair 10000 is typically made from a strong, but light weight and pliable canvas material, with a secure feeling for the person being lifted as well as an ergonomically correct and comfortable lift system for anyone using this application. Chair 10000 has both chest strapping 10110 and lap strapping 10210 with double sided buckles 10115 and 10215 for quick and easy closure and release. The person or patient (not shown) is typically secured into chair 10000 prior to relocation of the person.

Chair 10000 includes a lower portion 10200 and an upper portion 10100, which each can include a safety strap 10110 and 10210 in certain embodiments. The lower portion 10200 is generally positioned under the underside of the person or animal being moved, and the upper portion 10100 is generally positioned behind the back of the person or animal being moved. Throughout the remainder of this application, the term “person” is used to include both people and animals unless the context expressly indicates otherwise. The upper and lower portions 10100 and 10200 also include handles 10120, 10130, 10220, and 10230 that can be grasped by a user. In one embodiment, handles 10120 and 10130, as well as handles 10220 and 10230, are made from a continuous piece of seat belt webbing that extends along the width of the upper and lower portions 10100 and 10200. In one aspect, the chair 10000 includes a head support strap 10300 to provide support to the head of the person being transported. This feature can be especially important when moving someone in a weakened state in which neck movement is impaired.

The chair 10000 design, as well as the design of the other embodiments disclosed herein, have included considerations for weight distribution, handle placement, lifting comfort for placement of the patient, and user comfort of the lift method.

According to one aspect of the present invention, the strapping used in the various embodiments of the present invention disclosed herein are typically seat belt grade webbing, and have been weight tested and rated without product failure up to 4500 lbs. The webbing is typically 2 inch black seat belt webbing, known as 8233 polyester seatbelt webbing. The thread used to secure the various components of the embodiments described herein is typically Seraband thread, available from the Amann Group. In addition, the handles used according to the invention are designed to be compatible with conventional mechanical lift devices. The handles described for the various embodiments described throughout are likewise adapted for use in connection with a conventional mechanical lift device.

According to another aspect of the present invention, the material used to construct the various embodiments disclosed herein is a canvas material known as “Top Gun” material, which is an acrylic-coated 100 percent woven polyester fabric (100 denier) in which both the top and bottom surfaces of the fabric have been coated. This Top Gun material is available from Marchem Coated Fabrics, Inc. at 500 Orchard Street, New Haven, Mo. 63068. Other fabrics having similar characteristics can also be used in connection with the present invention. The material can be used with all other embodiments described herein in which a flexible material is used to support an object.

In another embodiment, a moving strap (not shown) similar to the strap used when moving large objects such as couches or refrigerators can optionally be used in connection with chair 10000, as well as any of the other embodiments described herein. The moving strap (not shown) can be looped through handles 10120, 10130, 10220, 10230, or around the entire chair 10000, and then wrapped around the arms and back of the person exerting the force to move the immobile person. The use of such a moving strap can provide more torque and potentially further reduce the likelihood back injury by enabling the person exerting the force to remain in a more upright position and use the legs to lift.

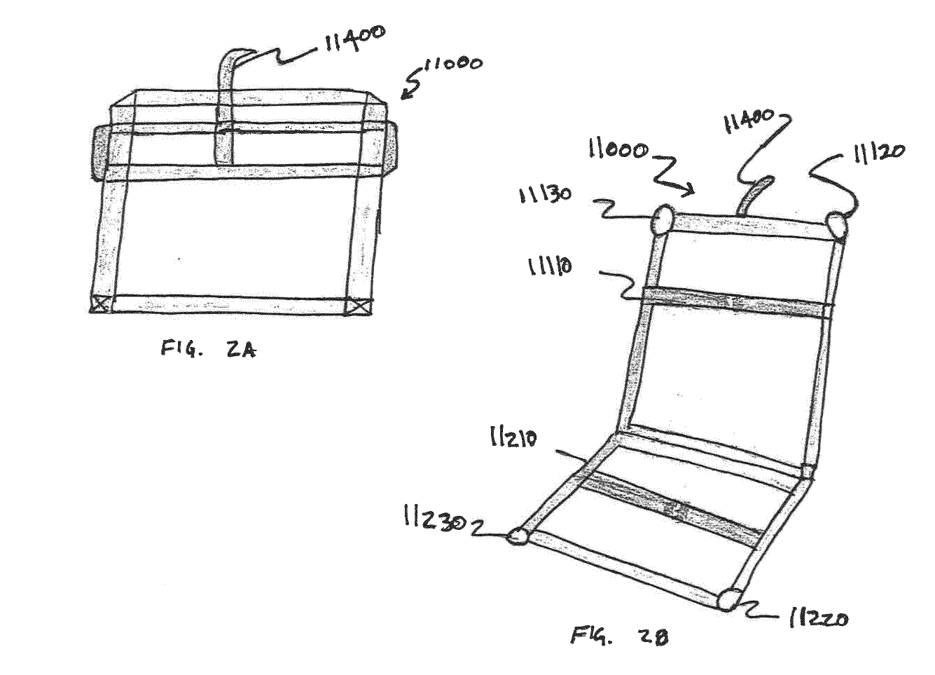

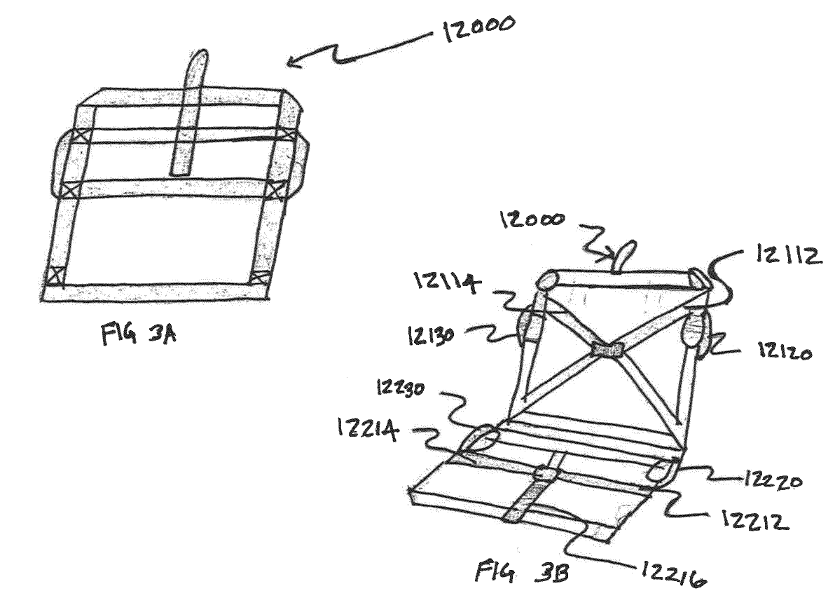

Referring to FIGS. 2A and 2B, a smaller rescue i recovery chair 11000 is shown. FIG. 2A shows the chair 11000 from a rear view. Similar to chair 10000, chair 11000 also includes safety straps 11110 and 11210. Chair 11000 further includes handles 11120, 11130, 11220, and 11230. In one aspect of the invention, this embodiment can be used in connection with circumstances including but not limited to movement onto a pontoon boat, movement from a wheelchair onto an airplane seat, movement from a wheel chair to a car, movement from a wheelchair into a stadium seat, and other similar movements. Using the present invention, the user typically does not need to touch the person, instead typically lifting with the handles once the person is strapped in, and in a single fluid movement, transfer without causing discomfort to the person being moved. In another aspect of the present invention, a person confined to a wheelchair or bed could enjoy being moved to a chair or sofa while allowing the seat or lift chair to remain in place. In another aspect, the present invention can have additional strapping 11400, typically Velcro, to be used if needed to secure an individual to a chair or seat.

FIGS. 3A and 3B shows another embodiment of a rescue/recovery chair 12000 in which the chest straps 12112 and 12114 are crossed instead of going straight across the chest of the person being transported, adding further stability. FIG. 3A shows the chair 12000 from a rear view. A three-piece lower strap 12212, 12214, and 12216 is also utilized to prevent the person being transport from sliding downwards in the chair 12000. Chair 12000 further includes handles 12120, 12130, 12220, and 12230.

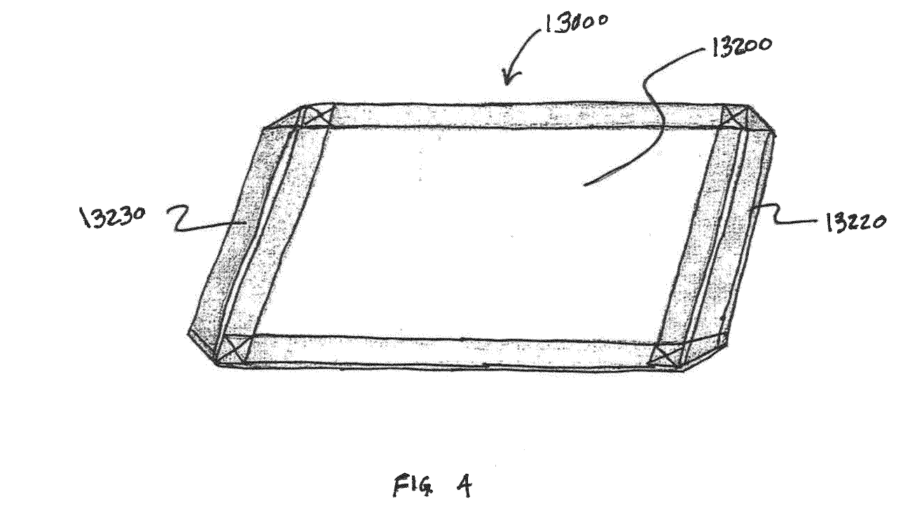

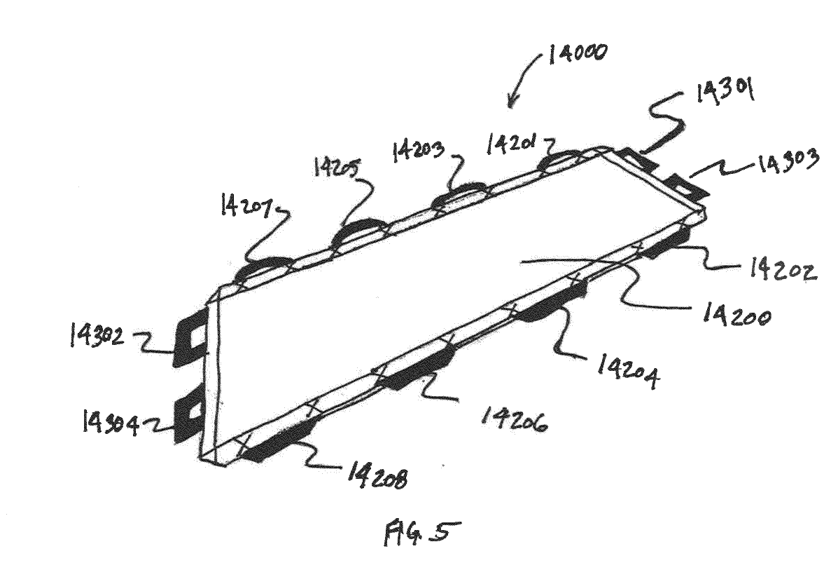

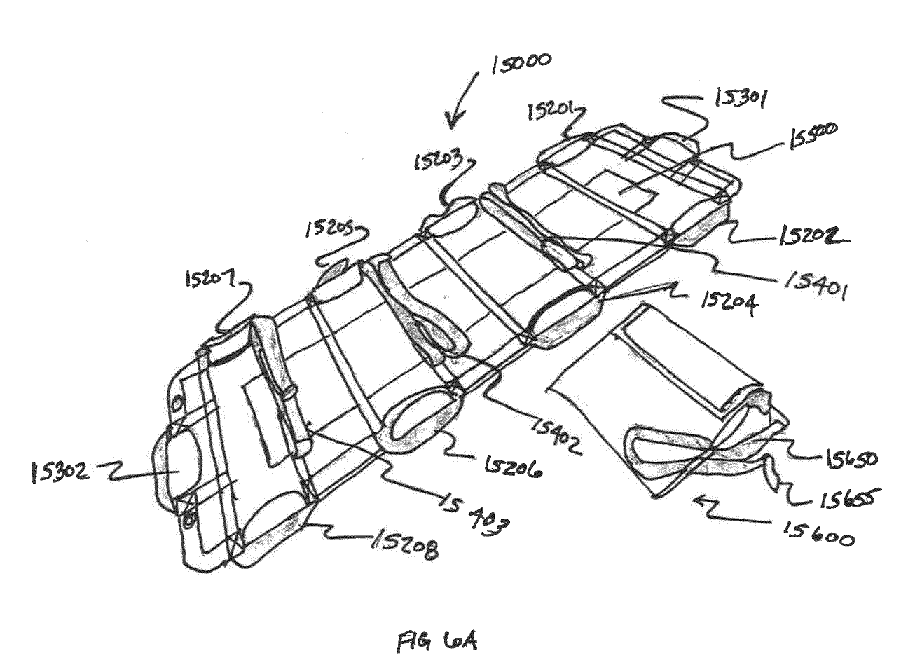

FIG. 4 shows another transfer chair 13000 according to the present invention in which only a lower portion 13200 is included. Handles 13220 and 13230 are disposed on opposite sides of the chair 13000. According to this embodiment, chair 13000 could be placed beneath a person in a wheelchair, seat, or other structure involving a seated position more easily When compared with a structure that also supports the back of the person being relocated.

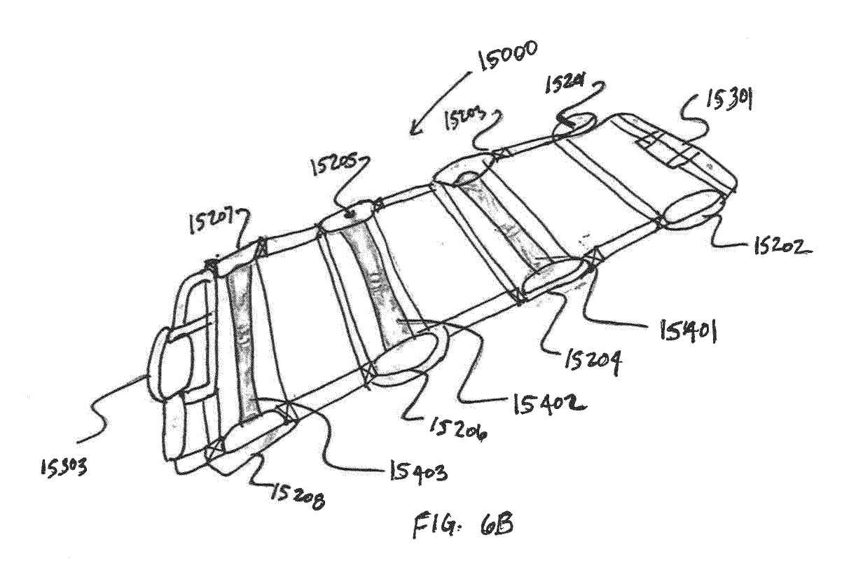

Referring to FIG. 5, a transfer sheet 14000 is shown. Transfer sheet 14000 is typically made of the same material as the sling chair and other embodiments disclosed herein. The dimensions of the transfer sheet 14000 are typically sized for a standard size hospital bed and the sheet 14000 is typically used during movement and transfer of a patient with simple lift and movement. Sheet 14000 typically includes side handles 14201-14208 and end handles 14301-304. In one aspect, the handle placement on sheet 14000 produces a weight distribution that that reduces the back strain and resulting injury that can be problematic for rescue and health care providers. In one embodiment, handles 14301-304 are constructed from continuous webbing loops such that each of handles 14201-202, 14203-204, 14205-206, and 14207-208 are typically made from a single webbing loop that continues across the width of sheet 14000.

In one aspect, the transfer sheet 14000 can make bathing, dressing, and moving a patient more comfortable and simplify the process. Although this application typically does not have any strapping to secure a person during movement, it can be used to transfer a person from a bed to a chair or other surface and left beneath the person reverse movement during times involving changing bed linens and physical therapy. As with the other embodiments disclosed herein, the material used for this embodiment is typically thin, light weight, nonabrasive, and easily slides under a person, for simple movement and transfer. Such smooth material typically reduces injury to skin, as in bed sores, skin ulcers, and as it can remain under the patient while in bed, eliminates excessive movement or contact of the skin by the caregiver. Stated another way, in one aspect, the sheet is constructed so that the surface that comes in contact with the person being transported does not include any rough edges or other protuberances that could scratch, rupture, or otherwise harm the skin of the person being transported. This is especially important in the case of people with diabetes or other conditions in which the skin can become susceptible to lesions, boils, and other conditions in which the skin surface can rupture or otherwise break down. The foregoing ‘7 discussion applies to the material that can be used with any of the embodiments described herein.

Transfer sheet 14000 can be constructed with smaller dimensions than those used for conventional hospital beds and used in connection with emergency medical systems and rescue operations, as well as for recovery and retrieval for in confined space extrication. The patient can be collared when needed for neck support, prior to movement, and then quickly transferred to the traditional hard board. The dimensions are standard for the hard board used for general purposes in most fire and rescue departments. This smaller application is also another option to be used in the hospital or home health care, to be left in the bed under sheets, for movement and transfer. In one embodiment, transfer sheet 14000 also includes a pocket (not shown) to receive a spine board or headboard (not shown) to immobilize the person being transported. Preferably, the stitching for the pocket would not extend through the upper surface of sheet 14000 to prevent any increased friction or damage to the skin of the person being transported.

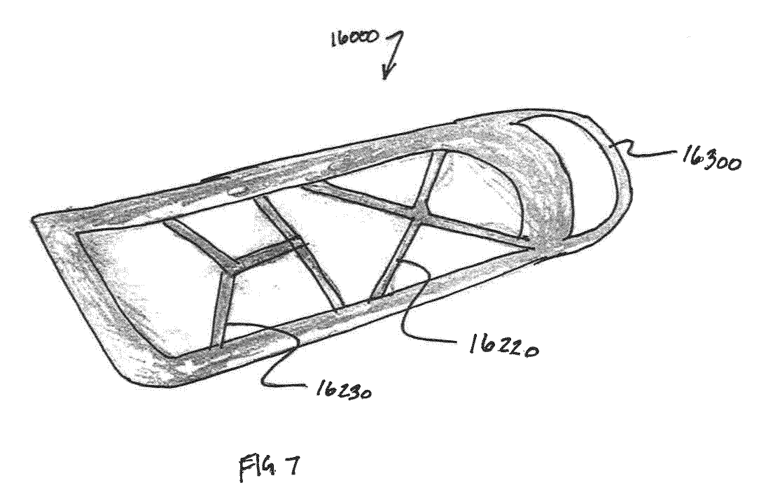

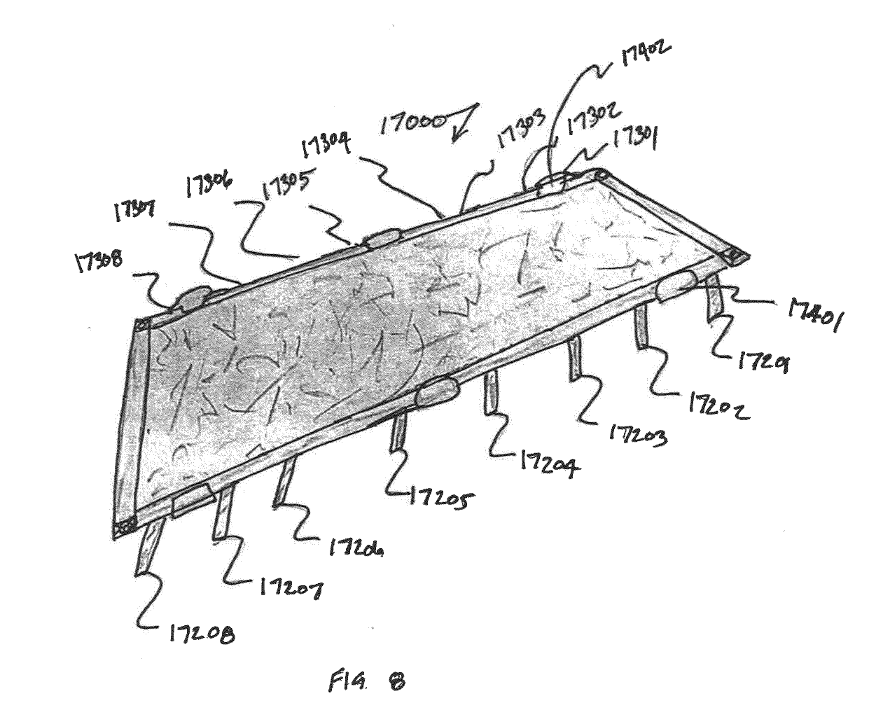

Referring to FIG. 6A, an extrication mat 15000 and carrying case 15600 are shown. Extrication mat typically includes safety straps 15401-403 to secure the person being transported using the mat 15000. In the embodiment shown in FIG. 6A, the straps come from underneath the mat 15000 and above and over the body of the person being transported in another embodiment shown in FIG. 6B, the straps 15401-403 are secured from the top surface of the mat. The embodiment of FIG. 6A is typically preferred because it eliminates the potential for skin injury to the person being moved and minimizes the impairment to the breathing of the person being moved. However, in certain circumstances, the “cocoon” effect resulting from the strap 15401-403 of FIG. 6B is preferred.

Referring to Fig, 613, extrication mat 15000 typically includes handles 15201-208 along all of its side surfaces. Extrication mat 15000 is typically made from a flexible material, which enables the mat to be folded into a compact size when not in use. As shown in FIG. 6A, according to one aspect of the present invention, mat 15000 can be folded into a carrying case 15600 that includes a shoulder strap 15650. The strap 15650 on the storage bag 15600 is removable, and the clip 15655 can be attached to the extrication mat 15000 to pull a patient from of a small space, and then further secured and lifted. One suitable usage for this application would be in areas of building collapse resulting from earthquakes or other natural disaster or situations involving trapped people. The soft, pliable material used in connection with this embodiment is compact and easy to slip into a confined space for rescue and retrieval.

Extrication mat 15000 can be especially useful in confined space rescue operations in which a conventional stretcher cannot be used. Bathrooms are a common location where people fall, and bathrooms typically have small, awkward configurations, making it difficult for EMS to work, adding time on to the rescue efforts and impeding immediate treatment and transfer of the patient. In one embodiment, extrication mat 15000 also includes a pocket 155600 to receive a spine board or headboard (not shown) to immobilize the person being transported.

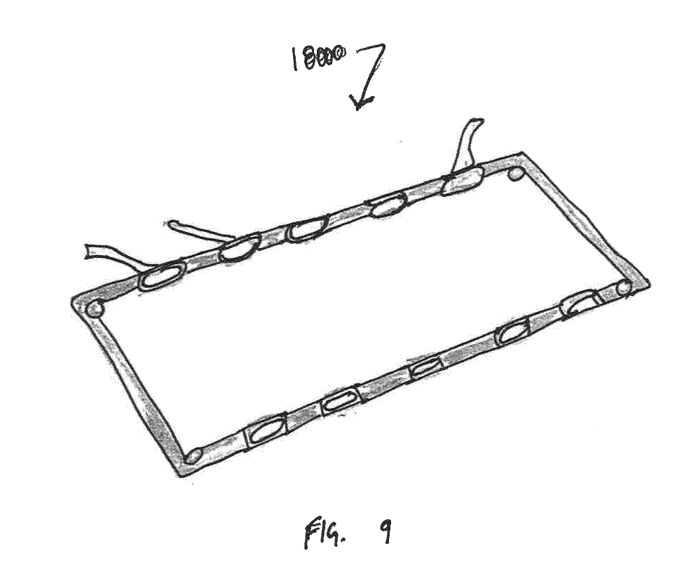

Referring to FIG. 7, an evacuation sled 16000 is shown. Evacuation sled 16000 is typically used in conjunction with transfer sheet 14000 and could be utilized in high-rise emergency situations such as hospital evacuations. During an emergency, transfer sheet 14000 can remain on the patient's bed, under the sheets, and the patient would be lifted from the bed with bed transfer sheet 14000. The patient would then be placed in the evacuation. sled 16000 and secured to the sled 16000 using straps 16220 and 16230 and evacuated with minimal contact to the patient.

Evacuation sled 16000 is typically a molded sled designed to gently and safely glide down each step, while being secured with a clip (not shown) to the railing and fire fighter or rescue worker during evacuation down a stairwell. The design also typically includes an attached handle 16300 that travels from one side of the sled to the other with the handle extending beyond the sled. Handle 16300 is typically used for secure lifting and turning in the stairwell landings during movement.

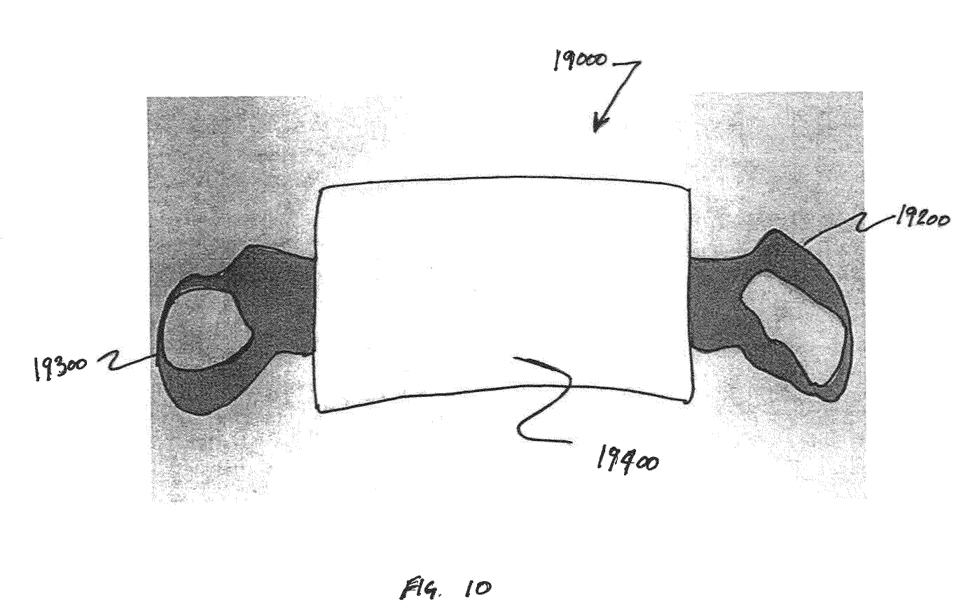

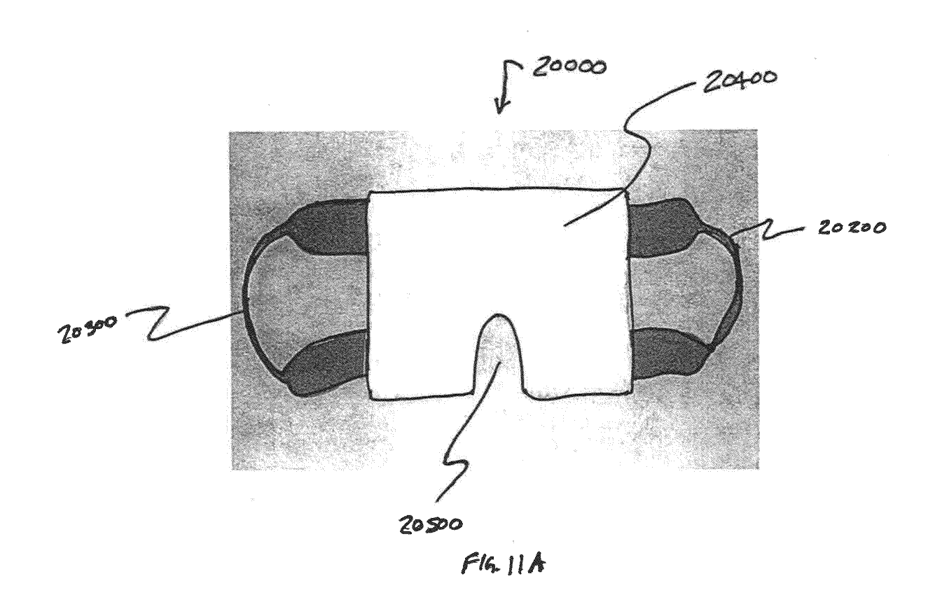

Referring to FIG. 8, a rough terrain extrication and transfer mat 17000 is shown. The transfer mat typically includes Velcro strapping 17201-208 that are interfaced with Velcro tabs 17301-308 to cocoon and secure a person or animal While being moved. The mat 17000 also can be used in conjunction with a thin plastic glider mat 18000 as shown in FIG. 9 and attached to handles 17401 and 17402. This embodiment can make the removal of an animal simple and easy, instead of the struggle of moving a deer, bear, or other hunted animal. This embodiment also could be used with a strap harness (not shown) such as a double clasp closure at the breast and lower rib cage area, with a metal loop on the back of the vest, to attach the “Y” Strap. The Y Strap could extend down to the rough terrain transfer mat, and attach at the corners. This would permit the patient (or animal if used during hunting), to be transported by one lead person simply “dragging or pulling” the transfer mat along behind. This embodiment also could have strap handles for lift assist during movement.

The plastic glider mat shown 18000 in FIG. 9, transfer mat 17000 shown in FIG. 8, and all strapping typically could be attached or enclosed with and to a carry bag (not shown) and rolled for storage and placed inside the bag, which is about the size of a sleeping bag, for ease of carrying and storage of the product.

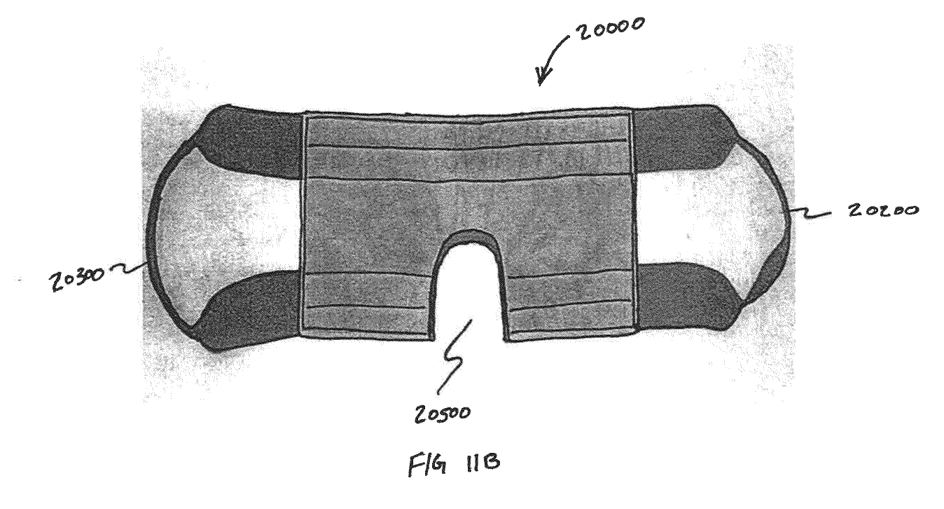

Referring to FIG. 10, an under-belly pet transfer sling 19000 is shown. This sling 19000 typically is placed underneath the belly of an animal to be transferred (not shown). Handles 19200 and 19300 are grasped by the user to assist in moving the animal. This could be used in connection with moving a dog or other four-legged animal. The sling typically includes a removable, washable pad 19400.

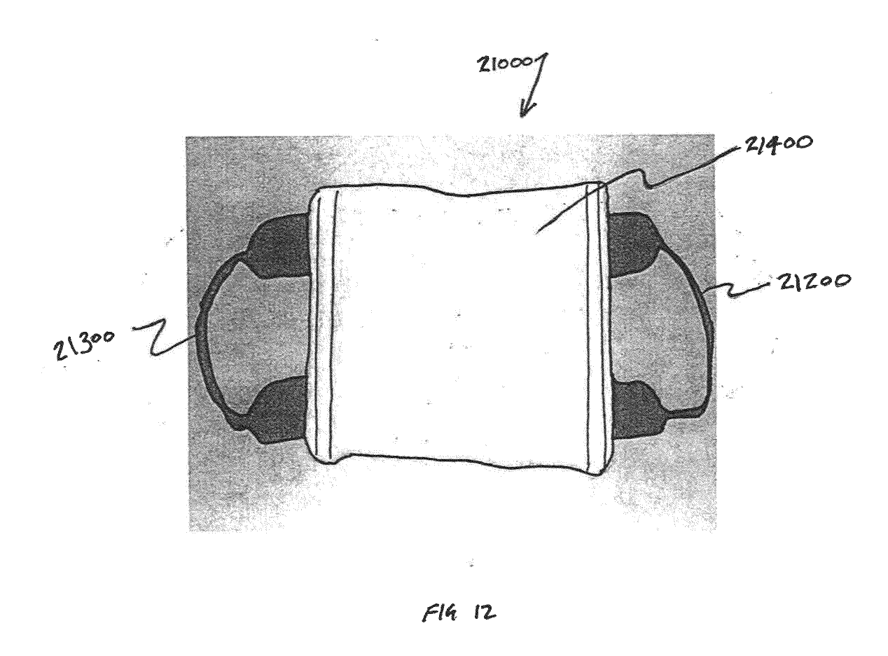

Referring to FIG. 11A, an alternate embodiment of an under-belly pet transfer sling 20000 is shown. This embodiment is similar to sling 19000 but further includes an cutout 20500 that permits the pet being transferred to urinate without having to be removed from sling 20000. Sling 20000 includes handles 20200 and 2.0300 and a removable, washable pad 20500. FIG. 11B shows sling 20000 without washable pad 20500.

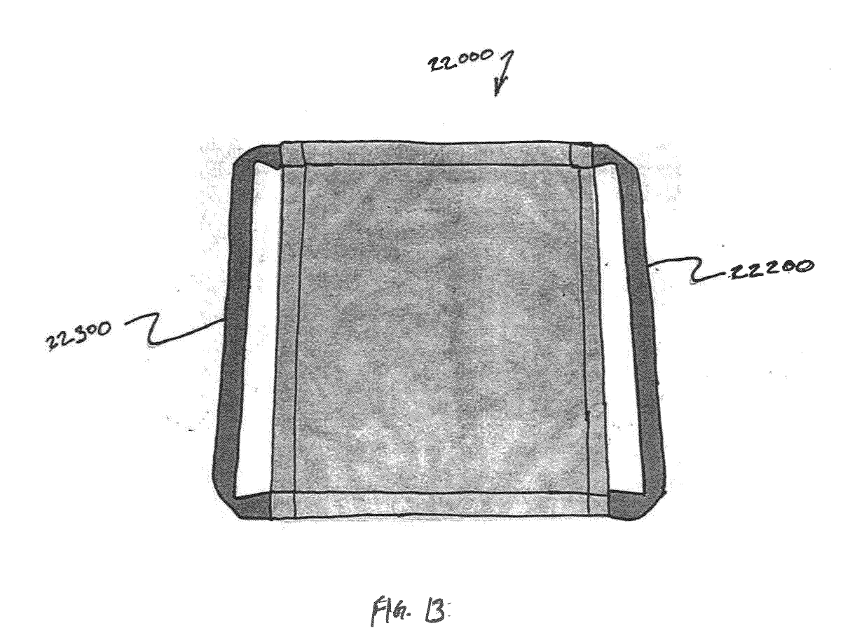

Referring to FIG. 12, a pet transfer mat 21000 is shown. This mat 21000 is typically used to envelope the animal being transferred. The mat 21000 can optionally include Velcro tabs (not shown) that are used to secure the outer edges of the mat together and securely hold an animal. Once the tabs are secured, a user typically grasps the handles to transport an animal.

Referring to FIG. 13, a large carry mat 22000 is shown. Mat 2.2000 is typically larger than slings 19000, 20000, and 21000 and is used to transport larger animals. Mat 22000 includes side handles 2.2200 and 22300.

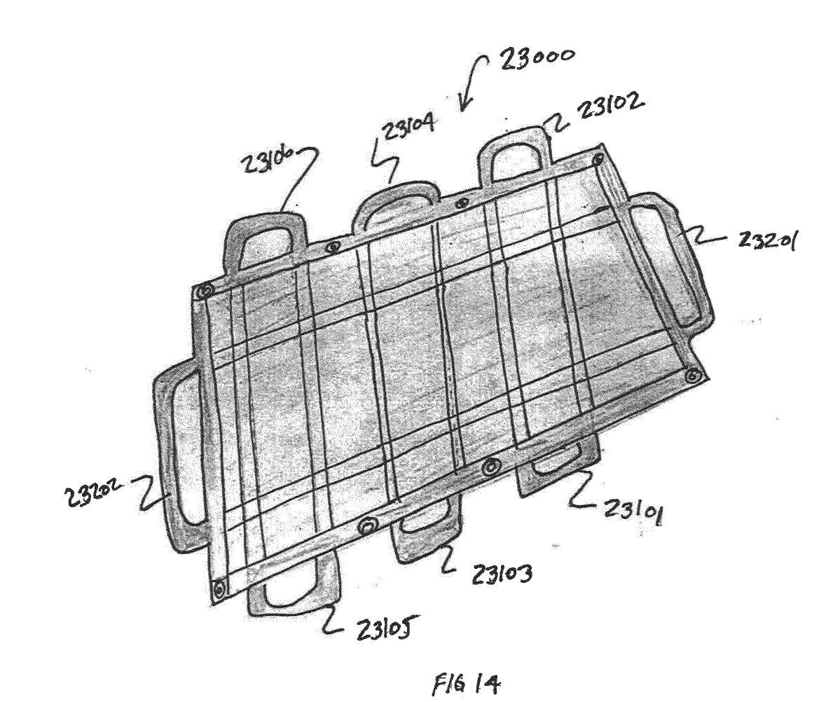

Referring to FIG. 14, an industrial cylinder transport mat 23000 is shown. This transport mat 23000 would typically be used in transporting cylinders or other large industrial items. This embodiment involves movement of industrial weight and size cylinders. Such movement is generally clumsy, and oftentimes dangerous. Mat 23000 includes side handles 23101-106 and end handles 23201 and 23202.

The elements and method steps described herein can be used in any combination whether explicitly described or not.

All combinations of method steps as used herein can be performed in any order, unless otherwise specified or clearly implied to the contrary by the context in which the referenced combination is made.

As used herein, the singular forms “a,” “an,” and “the” include plural referents unless the content clearly dictates otherwise.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All patents, patent publications, and peer-reviewed publications (i.e., “references”) cited herein are expressly incorporated by reference to the same extent as if each individual reference were specifically and individually indicated as being incorporated by reference. In case of conflict between the present disclosure and the incorporated references, the present disclosure controls.

It is understood that the invention is not confined to the particular construction and arrangement of parts herein illustrated and described, but embraces such modified forms thereof as come within the scope of the following claims.

What is claimed is:

1. An apparatus for moving a person, comprising:
a lower support surface constructed from a friction-reducing material;
a first support strap affixed to the lower support surface;
a first and second lower handle affixed to the lower support surface and disposed towards a rearward side of the lower support surface;
an upper support surface constructed from the friction-reducing material and interconnected with the lower support surface;
a second support strap affixed to the upper support surface;
a first and second upper handle affixed to the upper support surface and disposed towards a top side of the upper support surface and above the second support strap; and
a third support strap affixed to the upper support surface and disposed above the second support strap and towards a center, top side of the upper support surface.
